(19) United States
(12) Patent Application Publication
(10) Pub. No.: US 2013/0054429 A1
(43) Pub. Date: Feb. 28, 2013

(54) System and Method for Administering Deposit Accounts

(71) Applicants: Erik Minor, Caldwell, NJ (US); Joshua S. Siegel, New York, NY (US)

(72) Inventors: Erik Minor, Caldwell, NJ (US); Joshua S. Siegel, New York, NY (US)

(21) Appl. No.: 13/221,032

(22) Filed: Aug. 30, 2011

(51) Int. Cl. G06Q 40/00

(52) U.S. Cl. 705/30; 705/39

(57) ABSTRACT

Disclosed are systems, methods and computer program products for managing deposit accounts. A computer-based system allocates depositor funds among a plurality of FDIC-insured deposit accounts held in a plurality of deposit institutions, such as savings banks. The system establishes a deposit limit for each deposit institution to ensure that accounts always remains under the FDIC insurance limit and stabilizes the deposit base by facilitating movement of funds to and from participating deposit institutions through a trust account at a custodian institution. The system also automatically reconciles all balances and account activity on a daily basis to assure proper allocation of interest payments and bank fees. The system also performs a fully automated daily allocation process which provides detailed instruction to the custodian institution for the execution of cash allocation among the plurality of deposit institutions to ensure that all deposit accounts always remains under the FDIC insurance limit.

### TECHNICAL FIELD

The present invention relates to the field of finance and, in particular, to systems, methods and computer program products for administering funds from multiple depositors in deposit accounts at multiple banks, so that no single depositor holds funds in excess of the standard maximum deposit insurance amount (the “SMDIA”) offered by the Federal Deposit Insurance Corporation (“FDIC”) at any single depository bank.

### BACKGROUND

Financial management companies that provide asset management and investment services to individual and institutional investors with respect to fixed income (or debt) investments typically invest in bonds, loans, government and municipal securities and other debt investments, and mutual funds and other investment vehicles that invest in such debt investments. However, financial management companies rarely provide specialized management of depositor funds to be held in banks or credit unions or other institutions that offer FDIC insurance on deposits (referred to herein as “deposit institutions”). Deposit institutions offer different money saving options, such as money market accounts, savings account, CDs and other demand and time deposit accounts having fixed or variable interest rates and different maturity dates. Although deposit accounts may have lower interest rates than those offered by other debt instruments or debt funds, the funds held in deposit institutions are insured by the Federal Deposit Insurance Corporation (“FDIC”) provided the aggregate amount deposited in such deposit institution by a single depositor is under the standard maximum deposit insurance amount (the “SMDIA”).

There are existing extended FDIC programs that allocate amounts in excess of the SMDIA from a single depositor into multiple deposit institutions but such programs typically have a limited number of deposit institutions in their programs because these programs require special software or hardware that such deposit institutions must install and/or such deposit institutions must execute special documentation and/or agree to special terms. In addition, these other extended FDIC programs do not have the technical capabilities to integrate their account management systems with the disparate account management systems used by the various deposit institutions, which also limits the number of deposit institutions that participate in such programs. Because of these special requirements and/or limitations, such programs are unable to attract large numbers of deposit institutions and are therefore are able to offer only limited amounts of extended FDIC insurance coverage for depositors in these programs. The amount of FDIC insurance coverage offered by these programs is generally limited to the number of deposit institutions in such a program multiplied by the SMDIA. This arrangement may not be sufficient for wealthy individuals or institutions whose funds significantly exceed the FDIC insurance limit and therefore exceed the extended FDIC insurance offered by such other extended FDIC programs.

Accordingly, there is a need to provide a new financial management system for automated administration of funds from multiple depositors each of who has funds that exceed the FDIC insurance limit and in deposit accounts at multiple banks so that no single depositor holds funds in excess of the SMDIA at any single depository institution.

### SUMMARY

Disclosed are system and methods for automatically administering funds from multiple depositors in deposit accounts at multiple deposit banks, so that no single depositor holds funds in excess of the SMDIA at any single deposit institution.

In one example embodiment, the system offers to individuals and institutions a unique FDIC-insured product that provides competitive yield and liquidity by allocating amounts in excess of the SMDIA from a single depositor into multiple deposit institutions. In particular, the system allocates funds from multiple depositors among a plurality of FDIC-insured interest-bearing deposit accounts held in a plurality of deposit institutions. The system ensures that that no single depositor holds funds in excess of the SMDIA at any single deposit institution. The system utilizes a custodian account for each depositor at a custodian institution for the movement of depositor funds. The system automatically populates a general ledger and reconciles all balances and account activity on a daily basis. The system allocates interest payments and bank fees based on the reconciled balances and activity. The system performs a daily allocation process, which provides detailed instruction to the custodian institution for the execution of cash allocations among the plurality of deposit institutions to ensure that no single depositor holds funds in excess of the SMDIA at any single deposit institution. In addition, the system may also perform the daily allocation process based on other factors, including, but not limited to the financial health of a depository institution, the rates paid on the deposit accounts, the size of the depository institution, any banks exclusions provided by a depositor, and other factors. As part of the daily process, the system monitors for the news about mergers or closures of the participating deposit institutions in order to assure timely reallocation of depositor funds held in these institutions.

In one example embodiment, the account management system performs a process for automatic allocation of depositor funds among a plurality of FDIC-insured deposit accounts held in a plurality of deposit institutions, so that no single depositor holds funds in excess of the SMDIA at any single deposit institution. During the funds allocation process, the system sets a deposit limit for each deposit institution based on the current aggregate deposits at such institution to ensure that the aggregate amount of depositor funds deposited through the system held in each deposit institution remains below a certain percentage of such institution's total deposits. This limit is referred to as the aggregate deposit limit for such institution. The system also establishes a deposit limit for each depositor at each deposit institution in an amount less than the SMDIA to ensure that amounts that a depositor has on deposit in any deposit institution at any time is always under the SMDIA. This limit is referred to as the per depositor deposit limit (“PDDL”). The system then determines, based on the amount of depositor funds and the established aggregate deposit limit, a minimum number of different deposit institutions necessary for holding the depositor funds, so that no single depositor holds funds in excess of the PDDL at any single deposit institution. The system then determines, based on the various allocation factors, the amount of depositor funds to be deposited in each different deposit institution, but in each case limiting such deposit so that each deposit institution holds no more than the aggregate deposit limit for such deposit institution and so that no single depositor holds funds in excess of the PDDL at any single deposit institution. The system then instructs the custodian institution holding the depositor funds in custodian accounts to transfer the depositor funds to the deposit accounts at the depository institutions in the amounts determined by the system.

In another example embodiment, the account management system performs automatic reallocation of depositor funds among a plurality of deposit accounts held in a plurality of deposit institutions, so that no single depositor holds funds in excess of the SMDIA at any single deposit institution. In particular, the system receives from the deposit institutions where depositor funds are held records of transactions for each of the deposit accounts. The system determines, based on the records of transactions, if the amount of funds of any single depositor held in any of the deposit institutions exceeds the PDDL after a transaction. The system then instructs the custodian institution to reallocate from each deposit institution a portion of a depositor's funds that exceeds the PDDL after a transaction to at least one other deposit account in at least one different deposit institution, so that each deposit institution holds an aggregate amount of depositor funds that does not exceed the aggregate deposit limit for such deposit institution and the amount of funds from any single depositor held by any deposit institution remains under the SMDIA at all times regardless of activity type (e.g., interest, deposits, withdrawals or reallocations).

In another example embodiment, the account management system performs a process for daily account reconciliation and allocation of interest payments. The system stores in a database: (i) a general ledger file containing information about a total account balance in each deposit account and a transaction history of each deposit account; and (ii) a plurality of individual depositor records containing information about a daily account balance for each depositor in each of the plurality of deposit accounts. The system retrieves from the plurality of deposit institutions information about a daily account balance in each deposit account and a daily transaction history of each deposit account. The system automatically reconciles the records stored on the system with the records received from the deposit institution with respect to each of the deposit accounts.

During the reconciliation process, the system compares, for each deposit account, the total account balance from the general ledger file obtained from the database with the account balance obtained from a deposit institution. If the compared account balances are different, the system identifies in the daily transaction history obtained from the deposit institution at least one transaction (e.g., interest payment transaction made by the deposit institution that was not posted to the general ledger file) to account for the discrepancy. If the discrepancy is caused by an interest payment that was not posted on the general ledger, the system then identifies individual depositor records of one or more depositors whose funds are held in the deposit account where the interest payment transaction was made. The system then calculates what portion of the interest payment is to be allocated to each such depositor based on the daily balance of funds held in the deposit account for each depositor. The reconciliation processes ends with the system posting the calculated portions of the interest payment to the individual depositor records of each identified depositor.

Yet in another example embodiment, the account management system monitors for news about mergers or closures of the participating deposit institutions in order to assure timely reallocation of depositor funds held in these institutions. In particular, the system collects and analyzes information about each of said plurality of deposit institutions to identify mergers or closures of these institutions. In the event of a merger (or a closure which results in a merger) between two or more deposit institutions, the system determines if the total amount of a single depositor's funds held in the merged deposit institutions could exceed the SMDIA, in which case the system authorizes transfer of the potential excess portion of the depositor funds held in said merged deposit institutions to at least one other deposit account held in at least one other deposit institution, so that no single depositor holds funds in excess of the SMDIA at any single deposit institution. In the event of a closure of a deposit institution, the system selects one or more other deposit institutions for acquiring depositor funds held in the closed deposit institution, wherein no single depositor holds funds in excess of the SMDIA at any single acquiring deposit institution. The system then allocates depositor funds between the selected deposit institutions.

The above simplified summary of example embodiments serves to provide a basic understanding of the invention. This summary is not an extensive overview of all contemplated aspects of the invention, and is intended to neither identify key or critical elements of all embodiments nor delineate the scope of any or all embodiments. Its sole purpose is to present one or more embodiments in a simplified form as a prelude to the more detailed description of the invention that follows. To the accomplishment of the foregoing, the one or more embodiments comprise the features described and particularly pointed out in the claims.

### BRIEF DESCRIPTION OF THE DRAWINGS

The accompanying drawings, which are incorporated into and constitute a part of this specification, illustrate one or more example embodiments of the invention and, together with the detailed description serve to explain their principles and implementations.

In the drawings:

FIG. 1A illustrates a high-level diagram of the account management system according to one example embodiment.

FIG. 1B illustrates a detailed diagram of the account management system according to one example embodiment.

FIG. 2 illustrates a schematic diagram of the account reconciliation process according to one example embodiment.

FIG. 3 illustrates a schematic diagram of the daily allocation process according to one example embodiment.

FIG. 4 illustrates a schematic diagram of the interest allocation process according to one example embodiment.

FIG. 5 illustrates a schematic diagram of the interest allocation process according to one example embodiment.

FIG. 6 illustrates a flow diagram of the process for allocation of depositor funds among a plurality of deposit institutions according to another example embodiment.

FIG. 7 illustrates a flow diagram of the process for daily account reconciliation according to one example embodiment.

FIG. 8 illustrates a flow diagram of the process for allocation of interest payments according to one example embodiment.

FIG. 9 illustrates a flow diagram the process for allocation of depositor funds during mergers or closures of deposit institutions according to one example embodiment.

FIG. 10 illustrates a schematic diagram of a computer system according to one example embodiment.

### DETAILED DESCRIPTION OF EXAMPLE EMBODIMENTS

Example embodiments of the present invention are described herein in the context of systems, methods and computer program products for management deposit accounts holding depositor funds that exceed the FDIC insurance limit. Those of ordinary skill in the art will realize that the following description is illustrative only and is not intended to be in any way limiting. Other embodiments will readily suggest themselves to those skilled in the art having the benefit of this disclosure. Reference will now be made in detail to implementations of the example embodiments of the invention as illustrated in the accompanying drawings. The same reference indicators will be used to the extent possible throughout the drawings and the following description to refer to the same or like items.

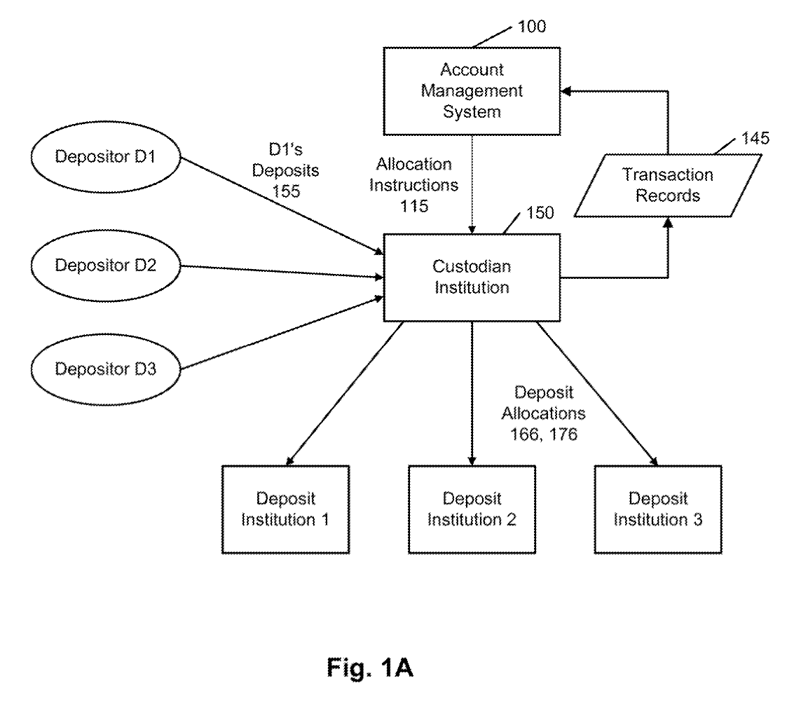

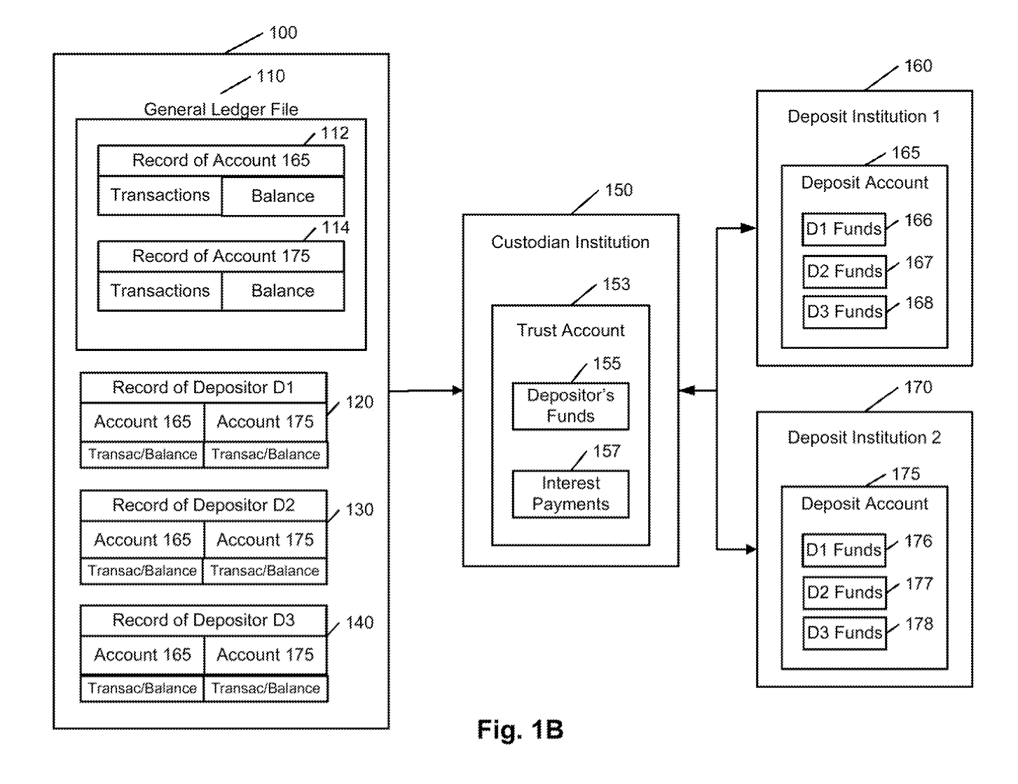

FIGS. 1A and 1B show schematic diagrams of the account management system in accordance with one example embodiment. The system 100 may be implemented as a software application deployed on a general-purpose computer or a network server. The system 100 manages depositors' deposits 155 across a broad spectrum of participating deposit institutions 1, 2, 3, such as savings banks 160 and 170. The number of deposit institutions in which depositor funds may be deposited is not limited and may depend on the number of depositors and amount of funds managed by the system 100. The account management system 100 allocates depositor funds 166, 176 in the FDIC-insured deposit institutions 160 and 170 in order to maximize coverage for each depositor utilizing FDIC's pass-through insurance up to the current maximum amount of $250,000 at each institution; however, that limit may change in the future. All depositor deposits may be held in interest-bearing demand deposit accounts, such as money market and savings accounts 165 and 175, which preferably do not have fixed maturity dates. The depositor funds 155 may be moved to and from the deposit institutions 160 and 170 through a custodian account for each depositor 153 held at a custodian institution.

In one example embodiment, the system 100 is configured to allocate a depositor's funds that exceed the FDIC insurance limit among several deposit institutions 1, 2, 3, so that the total amount of a single depositor's funds held in any deposit institution does not exceed the SMDIA. For example, as shown in FIG. 1B, funds of depositor D1, which may or may not exceed the FDIC insurance limit, may be divided into two portions 166 and 176 and allocated between accounts 165 and 175 held in different deposit institutions 160 and 170, respectively. Similar allocation process may be performed with the funds of depositors D2 and D3. As a result, funds of depositors D1, D2 and D3 are allocated into accounts 165 and 175 held in different deposit institutions 160 and 170, respectively, so that no single depositor holds funds in excess of the SMDIA at any single deposit institution. The allocation of depositor funds may be performed by the custodian institution 150 through the custodian account 153 for each depositor based on allocation instructions 115 from the system.

In addition, to assure that no single depositor holds funds in excess of the SMDIA at any single deposit institution, due to, for example, interest payments by the deposit institutions, which may potentially bring the balance of a depositor's funds above the SMDIA for a deposit institution, the system 100 sets a deposit limit for each depositor at each deposit institution below the SMDIA (such per depositor deposit limit referred to as the PDDL) and monitors when the balance of any single depositor's funds at a single deposit institution exceeds the preset deposit limit per depositor. In particular, the system may obtain from each of the deposit institutions 160 and 170 (or from the custodian institution 150) daily transaction records 145 for each deposit account. If the records 145 indicate that the amount of a depositor's funds held in any one of the deposit institutions exceeds the PDDL, the system 100 may instruct the custodian institution 150 to transfer, from each deposit account, a portion of a single depositor's funds 155 or 157 that exceeds the PDDL to at least one other deposit account in at least one different deposit institution, so that each deposit account holds a portion of a depositor's funds that does not exceed the PDDL and the amount of a single depositor's funds held at any deposit institution remains under the SMDIA.

Yet in another example embodiment, to keep track of the movement of depositor funds and the balance of funds in the deposit accounts, the system 100 may create a general ledger file 100 comprising a plurality of individual depositor records 120-140 and store such file in a database (not shown). The general ledger file 110 may include a plurality of account records 112 and 114 that contain information about account balances and transaction history for each deposit account and each depositor account managed by the system 100. For example, as shown in FIG. 1B, record 112 may include transaction history and account balance for deposit account 165 held at the deposit institution 160; and record 114 may include transaction history and account balance for deposit account 175 held at the deposit institution 170. Similarly, individual depositor records 120-140 contain information about the transaction history and daily account balance for each deposit account where a depositor's funds are held. In addition, individual depositor records 120-140 may include a depositor's identification and contact information as well as a depositor's preferences information (such as their bank exclusion list) and other types of information.

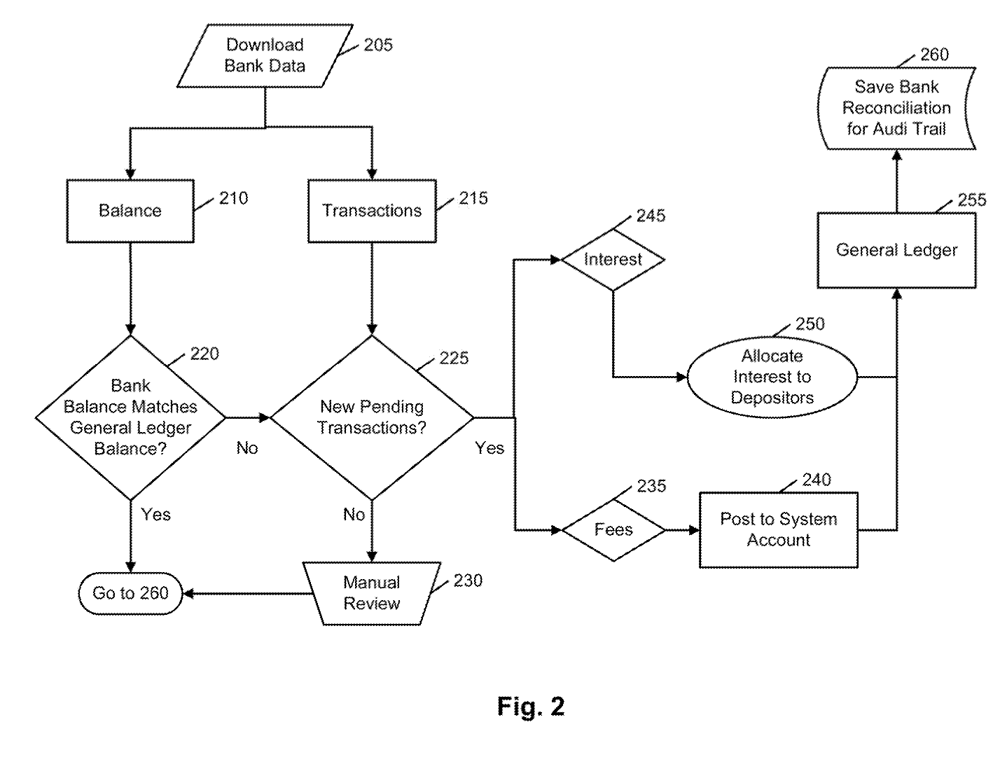

In one example embodiment, the account management system 100 automatically performs “Daily Reconciliation Process” of all deposit institutions and all deposit accounts. FIG. 2 depicts a schematic diagram of this process. At step 205, the system 100 downloads bank activity information from each participating deposit institution. The system receives the account balance 210 and transaction records 215 specific to each deposit account where depositor funds are held. The account balance 210 is the current dollar amount held in the account as reported by the bank. The transaction record 215 provides a detail of any transaction that occurred. In one example embodiment, the system 100 automatically creates two output files for each deposit institution, one for the account balance and one for transaction records. The output data is saved in a designated output folder and stored for the day's reconciliation process. If an extraction error occurs during data download from any of the participating deposit institutions, an Exception Report may be generated, which flags the file for manual review. The Systems Administrator may trouble shoot and resolve the error. Once the extraction errors are resolved the deposit institution's data is ready be reconciled.

It should be noted that the organization of captured data of each deposit institution is facilitated by the system's ability to assign a unique identifier to multiple levels of data. In one example embodiment, the data levels may include, but are not limited to: (i) an individual deposit institution within the pool of participating deposit institutions, which may be identified by a unique FDIC certificate number; (ii) a deposit account within each deposit institution, which may be identified by the last four digits of the account number; and the transaction history for each deposit account. Additional data levels may be used in other embodiments.

Next, at step 220, the system performs a comparison of the downloaded bank balance and transactions with the general ledger balance (sum of all cleared transactions) and transactions to ensure that they match. If these balances and transactions match, then the deposit institution data is reconciled for the day and the reconciliation data is stored to provide an audit trail at step 260. If the deposit account balances and the general ledger balance do not match, the system 100 will identify and document all differences, and determine at step 225, if there are any pending transactions that have not been posted to the general ledger. For example, the system may generate a Review Pending Items Report which is used to identify any new transactions that are to be posted in order to balance the deposit account balances at the deposit institutions with the general ledger. The Report may also contain a description of the new transactions, which allows the new transactions to be easily identified and reviewed.

In one example embodiment, the pending transactions may be either interest paid by the deposit institution or fees imposed by the deposit institution. If it is determined that the pending transaction is not either interest or fees, the Exception Report may be generated and submitted for manually review at step 230. If the transaction activity is interest or fees, the system verifies the transactions and prepares them for posting to the appropriate general ledger accounts. If the transaction activity is a fee 235, the fee may be posted to a system account 240 in the general ledger 255. If the transaction activity is an interest payment 245, the interest is systemically allocated at step 250 to all depositors who have deposits with the deposit institution. In one example embodiment, the amount of allocation may be based on the daily balance of a depositor's funds. The allocated interest is then posted to depositors' accounts in the general ledger 255 and individual depositor records.

Lastly, at step 260, the system may generate a Bank Reconciliation Report which displays any pending transactions and all previously posted transactions. The new transactions can only be posted if the sum of all new transactions and previously posted transactions equals the ledger balance. Daily reconciliation process is complete when the status indicates that there are no pending items and the Bank Reconciliation Report shows that the deposit institution balance and the general ledger balance match. All reports that are specific to the deposit institutions reconciliation process for each day may be stored in the system database. When all the Deposit Institution Reconciliation Reports are generated and stored, the Daily Reconciliation Process is terminated.

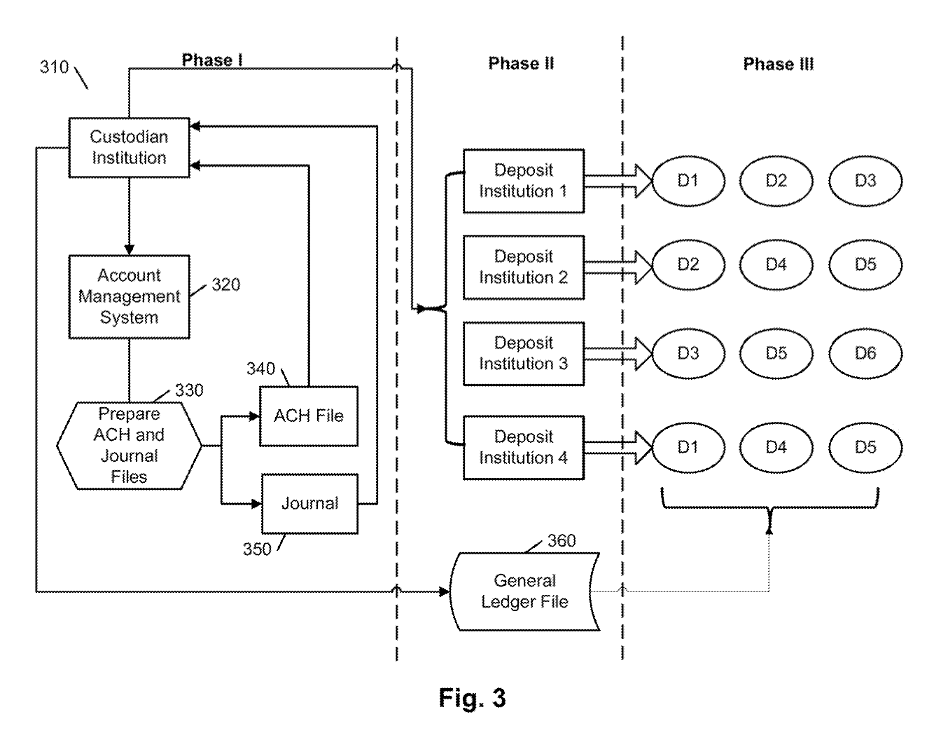

In one example embodiment, the Daily Reconciliation Process describe above may be followed by a “Daily Allocation Process”. During this process, the account management system 100 provides instructions for the movement of funds between the custodian institution 150 and the participating deposit institutions 160 and 170 and also breaks down the aggregate deposit institution balance to the individual depositor level at the participating deposit institutions 160 and 170. FIG. 3 depicts a schematic diagram of the daily allocation process in accordance with one example embodiment. The process may begin at the start of each business day when the custodian institution 310 sends transaction records 145 to the system 320. The transaction records 145 may be transmitted via secured file transfer protocols. Preferably, within one hour of receipt of the transaction records 145, the system 320 generates at step 330 an ACH (Automated Clearing House) file 340, which instructs the custodian institution 310 how to allocate using ACH the net cash flows for each of the participating deposit institutions. The ACH file provides the deposit institution level detail. The ACH file is also the vehicle used to ensure that no single depositor holds funds in excess of the SMDIA at any single deposit institution and provides the data for rebalancing the depositors' custodian accounts. Preferably, within two hours of receiving the transaction records 145 from the custodian institution 320, the system 100 creates a Journal file 350 that provides a breakdown of depositor balances by bank and account activity data. The files are transmitted to the custodian institution 310, which in turn originates ACH transfers of funds between deposit accounts in different deposit institutions. It should be noted that the indicated time limits for generation of the ACH and Journal files are merely exemplary and can be changed depending on various business and technical criteria.

As shown in FIG. 3, the daily allocation process may be divided into three phases:

During Phase I of process, the database of system 320 is prepped to receive and store the transaction records for the day and ensures that information on each deposit institution in the program has been updated. The updated information provides one of the main security features to the system. It ensures that system 320 is immediately alerted to any deposit institution mergers and failures of deposit institutions participating where depositor funds are allocated. The system also receives daily email alerts of public deposit institution data from published news sources and the FDIC detailing any mergers or failures, as will be described in greater detail herein below. These parameters ensure that in the rare event that the FDIC assumes the deposits of a failed deposit institution; an immediate claim can be initiated on behalf of each depositor with deposits in that failed deposit institution. The system 320 may also automatically generate a file for the FDIC in the required format with all the necessary depositor detail. This file is sent by the custodian institution 310 to the FDIC. This also ensures that depositor funds are transferred to other participating deposit institutions in the program. Additionally, the system ensures the immediate reallocation of cash balances in the event of a merger between participating deposit institutions. A reallocation to another deposit institution will only be triggered, if the account balances now held at the merged deposit institution, exceeds the preset aggregate deposit limit for such merged institution or if a single depositor may hold funds in excess of the PDDL at the merged deposit institution.

During Phase II of the process, the system 320 computes the net depositor cash transaction amount for the day (which may be positive or negative) and allocates such amounts to the participating deposit institutions. Once this phase is executed, the ACH file which is generated containing the allocation instructions for each deposit institution is sent to the custodian institution 310. The custodian institution then prepares all ACH originations for each participating deposit institutions to be executed the same business day. If there is no cash movement for the day, a blank ACH file may still be transmitted to the custodian institution. This ensures that there is a file generated each business day for audit purposes.

During Phase III of the process, the system 320 breaks the cash allocation down to the depositor level at each deposit institution and generates a Journal file. The Journal file is transmitted to the custodian institution 310 and is used by the custodian to post transactions to the individual depositor's accounts with respect to each deposit institution. The account details may be stored in a database and provides the input for the depositor's monthly statement. The Journal file is sent to the custodian institution 310 daily preferably simultaneously with the sending of the ACH file.

Phases II and III may be time stamped to ensure processing prior to the designated cut off times, this ensures same day processing which contributes to both the liquidity of the depositor's account as well as maximizes the time in which the depositor's balances earn interest. It should be noted that the indicated time limits for generation of the ACH and Journal files are merely exemplary and can be changed depending on various business and technical criteria.

In one example embodiment, the account management system 100 proactively monitors the safety and soundness of participating deposit institutions by reviewing up to date public information as published by the Federal Reserve and news services, so that, in the event of merger of participating deposit institutions or failure of one or more deposit institutions, appropriate actions may be taken by the account management system 100.

For example, if the deposits are acquired by another deposit institution, the system 100 will determine if it acquiring deposit institution is one of the participating deposit institutions. If the acquiring deposit institution is not in the program, the system 100 will assign a unique identifier for the acquiring deposit institution that will allow the deposit accounts to be transferred from the acquired program deposit institution. The allocation instructions 115 are given to the custodian institution. This process allows accounts to be transferred to the acquiring deposit institution instead of closed.

If the acquiring deposit institution is one of the participating deposit institutions, the system 100 will automatically perform the above-described reallocation process, and will instruct the custodian institution to reallocate balances to ensure that no single depositor holds funds in excess of the SMDIA at the acquiring deposit institution.

If the FDIC has taken over the failed bank, the system 100 automatically generates a file for the FDIC in the correct format with all the depositor details necessary to file a claim. The custodian institution only has to forward the file to the FDIC. Once the claim has been settled the custodian institution will move the cash to other participating deposit institutions based on allocation instructions sent by the account management system 100.

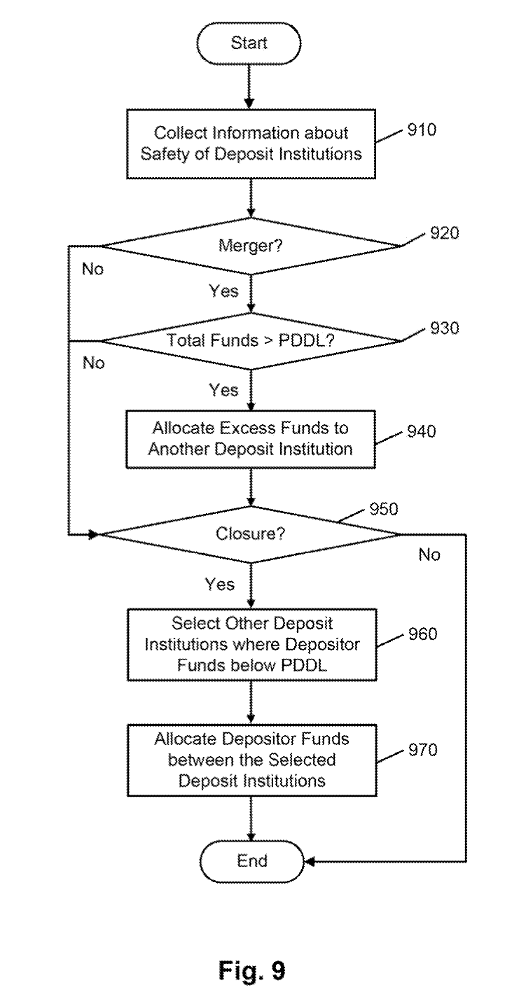

In the event of a merger between participating deposit institutions, the system 100 will automatically perform the above-described reallocation process, and will instruct the custodian institution to reallocate balances to ensure that no single depositor holds funds in excess of the SMDIA at the acquiring deposit institution, as will be described in greater detail herein below with referenced to FIG. 9.

In one example embodiment, the account management system 100 allows depositors to specify various preferences with respect to allocation of funds in the deposit institutions. For example, during registration with the system 100, all depositors are given the option to provide a list of deposit institutions in which they do not want their funds deposited (“Exclusion List”). The Exclusion List remains in effect as long as the depositor has funds on deposit with the system 100 and becomes part of the system that ensures that the system does not allocate such depositor's funds into deposit institutions on the Exclusion List. The system ensures a fully automated exclusion process that does not require manual intervention each time an allocation is performed on behalf of the depositor.

In one example embodiment, the account management system 100 does not require negotiated interest rates with the participating deposit institutions and will accept the deposit institution's offered rate. Interest rates are determined at the discretion of the deposit institution based on prevailing economic and business conditions and are subject to change at any time without notice. As indicated above, depositor funds are deposited in interest-bearing demand deposit accounts, such as money market and savings accounts, which offer a variable rate without a fixed maturity. This provides maximum flexibility in the allocation of interest across all depositors.

This feature is unique to the account management system of the present invention. The reason is that other extended FDIC deposit systems require participating banks to agree to a pre-set formula (e.g., Fed rate+3 bps). What this means from a participating bank's perspective is that the bank's treasurer must create a special process to deal with this funding source. This takes time and adds complexity to the bank's Asset Liability Management Process. On the other hand, the account management system 100 allows the treasurer of a participating deposit institution to manage the deposit accounts in the same fashion as every other bank account and therefore affords the treasurer a greater amount of flexibility and no additional work. This in turn makes deposit institutions more willing to participate in the services provided by the account management system 100 and therefore expand the pool of participating deposit institutions.

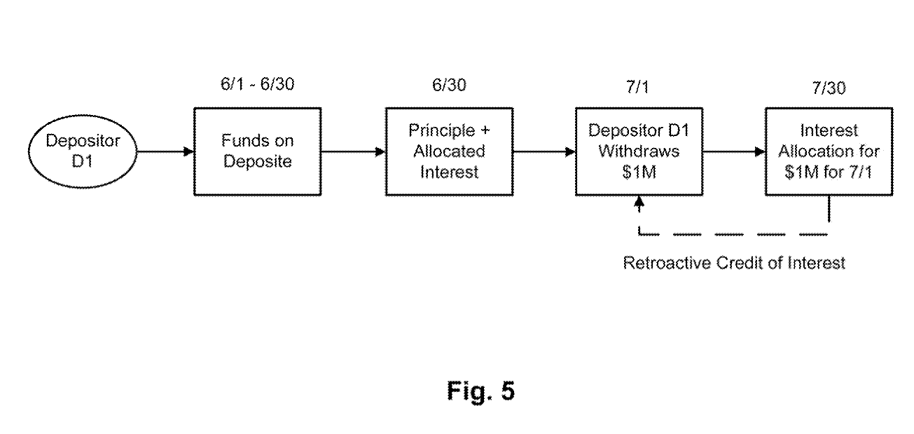

By requiring deposit institutions to agree to a preset formula, other extended FDIC deposit systems are able to calculate interest on a daily basis. But because of the complexities of participating in an extended FDIC financial deposit system that require a predetermined rate (as described above), banks typically offer a lower rate to those financial systems. In contrast, the account management system 100 deposits depositor funds in variable rate accounts and therefore simply takes the rate when the interest is applied to the deposit account and then allocates the interest to depositors' accounts when paid by the deposit institution. This allocation of interest requires substantial amounts of computations, but allows the account management system 100 to receive the higher rates that deposit institutions generally offer for accounts that do not require a deposit institution to have special software or hardware or to offer a predetermined rate. The process of the interest allocation to depositors when interest is paid by a deposit institution will be described herein below with reference to FIG. 5.

In one example embodiment, the account management system 100 runs a fully automated process to allocate and credit interest to the depositors. All depositors with deposits at a given deposit institution receive an allocation of interest based on their daily account balance. Interest paid by the deposit institution is captured from the daily transaction download and is allocated through the daily reconciliation process. Since interest rates are not negotiated and may fluctuate, depositors receive the actual rate paid by each deposit institution on their respective deposit at such deposit institution. Unlike other financial systems that credit interest based on a fixed maturity date, the account management system 100 credits interest to depositors as and when it is received from each depository institution and is not restricted to any particular day of the month. Since the system allows interest to be credited to the depositor's account on any day of the month, the interest is reconciled as it is received and does not require any manual interest calculations. All interest credited to a depositor is automatically reinvested for the account of the depositor.

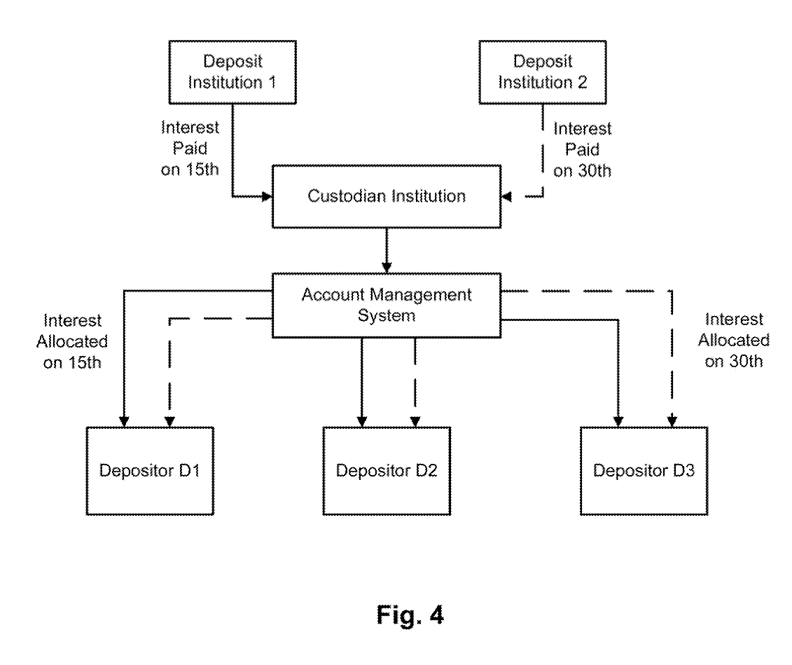

FIG. 4 shows a diagram of a process of automatic interest allocation implemented by the account management system in accordance with one example embodiment. As shown, if a depository institution pays interest on the 15th of the month, the account management system 100 makes an interest allocation and credits depositors effective that day. If interest is paid by the deposit institution on the 30th of the month, the system 100 will perform the interest allocation effective that day. In contrast, other extended FDIC deposit systems generally credit interest based on a fixed maturity date.

In one example embodiment, the account management system 100 allocates interest on funds that depositors had on deposit for a partial month on the date a deposit institution pays interest. In particular, the system 100 automatically tracks a depositor's balances on a daily basis so that even if funds are withdrawn during the statement cycle, the depositor is allocated and is credited his share of the interest when it is paid by the deposit institution at the end of the next statement cycle. The interest allocation is based on the daily balance that a depositor has in a deposit account for the interest period. The interest may be paid at the end of the interest period and not at the time of withdrawal of the funds as is generally practiced by other extended FDIC deposit systems.

FIG. 5 shows a diagram of a process of interest allocation implemented in the account management system 100 in accordance with one example embodiment. As shown, depositor D1 maintains funds in a deposit institution throughout the month of June. If the deposit institution pays interest on June 30th, the system allocates interest to a depositor on such date based on the daily balance that a depositor has in the deposit account at such deposit institution for the entire interest period. If the depositor withdraws funds from the system the withdrawal is allocated to the deposit account at a deposit institution in the amount of “principal” on, for example, July 1st, the depositor receives the principal but not the interest that has accrued since the last payment date would be paid at the time of withdrawal. On for example, July 31^{st}, when the deposit institution next pays interest, the system will calculate the depositor's share of interest and allocate such share of the interest to the depositor based on the daily balance that the depositor has in the deposit account during such interest period. By crediting interest on the dates that deposit institutions pay interest, the system does not require the use of one depositor's funds to pay another withdrawing depositor's accrued interest that has not yet been paid by a deposit institution and eliminates the liquidity risk in the event an outside institution, like a bank, provide funds for interest accrued but not yet paid by a deposit institution.

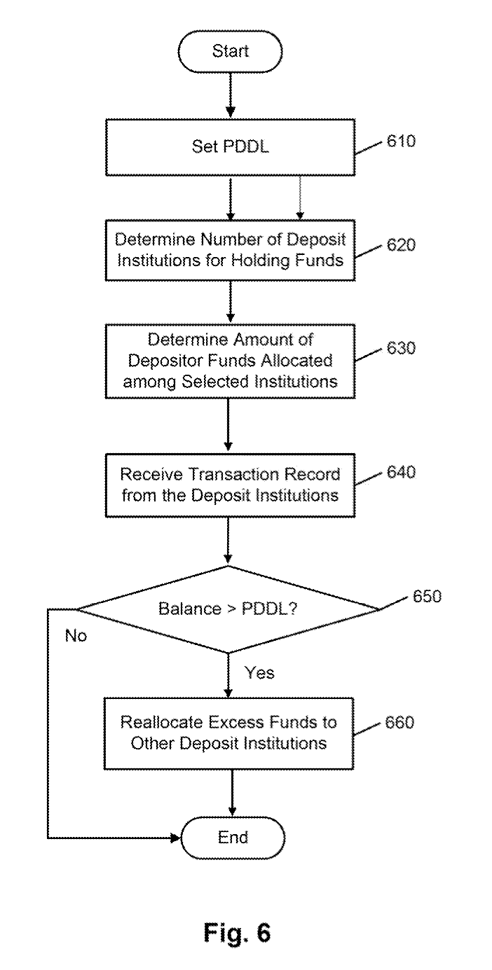

FIG. 6 depicts one example embodiment of a process for allocation of depositor funds among a plurality of deposit institutions. At step 610, the account management system 100 sets a deposit limit for each deposit institution based on the current aggregate deposits at such institution to ensure that the amount of depositor funds deposited through the system held in each deposit institution remains below a certain percentage of such institution's total deposits. Also at step 610, the system establishes a deposit limit for each depositor at each deposit institution in an amount less than the SMDIA to ensure that amounts that a depositor has on deposit in any deposit institution at any time is always under the SMDIA. This limit is referred to as the deposit limit per depositor deposit limit or PDDL. At step 620, the system then determines, based on the amount of depositor funds and the established aggregate deposit limit and the PDDL, a minimum number of different deposit institutions necessary for holding the depositor funds, so that no single depositor holds funds in excess of the PDDL at any single deposit institution. At step 630, the system then determines, based on the various allocation factors, the amount of depositor funds to be deposited in each different deposit institution, so that each deposit institution holds no more than the aggregate deposit limit for such deposit institution and so that no single depositor holds funds in excess of the PDDL at any single deposit institution. At step 640, the system receives from the deposit institutions where depositor funds are deposited (or from the custodian institution) transaction records for each of the deposit accounts. At step 650, the system determines, based on the transaction records, if the amount of an individual depositor's funds held in any of the deposit institutions exceeds the PDDL. If the amount of a depositor's funds held in any of the deposit institutions exceeds the PDDL, the system, at step 660, instructs the custodian institution to reallocate from any deposit institution a portion of such depositor's funds that exceeds the PDDL to at least one other deposit account in at least one different deposit institution, so as to ensure that no single depositor holds funds in excess of the SMDIA at any single deposit institution.

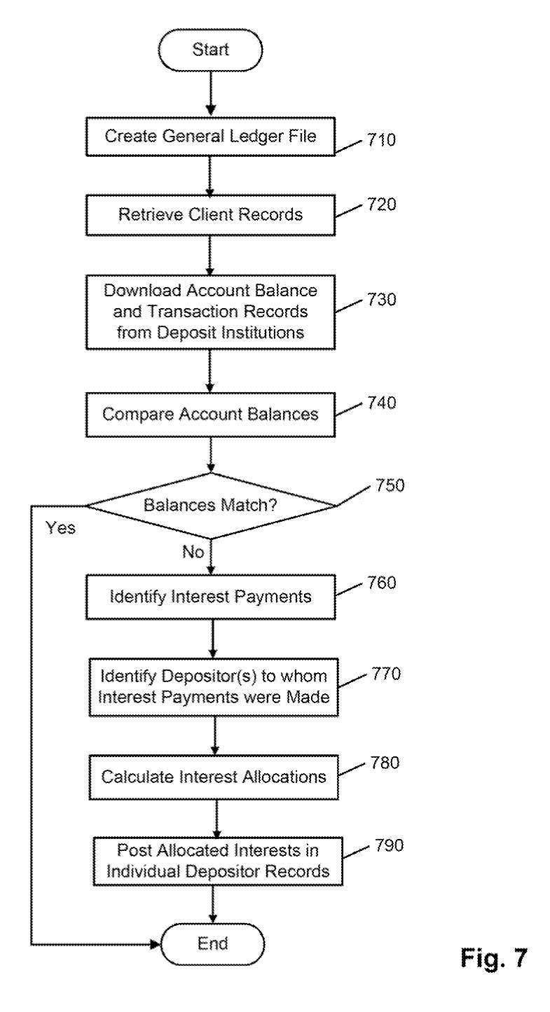

FIG. 7 depicts one example embodiment of a process for daily account reconciliation. At step 710, the system retrieves from the database a general ledger file containing information about aggregate account balances in each deposit account and a transaction history of each deposit account. At step 720, the system retrieves from the database a plurality of individual depositor records containing information about a daily account balance for each depositor in each of the plurality of deposit accounts. At step 730, the system downloads from the plurality of deposit institutions information about a daily account balance in each deposit account and a daily transaction history of each deposit account. At step 740, the system than reconciles each of the deposit accounts by comparing, at step 750, for each deposit account, the total account balance and transactions from the general ledger file obtained from the database with the daily account balance and transactions obtained from a deposit institution. If the compared account balances are different or the transactions are different, the system, at step 760, identifies in the daily transaction history obtained from the deposit institution at least one transaction (e.g., interest payment transaction) made by the deposit institution that was not posted to the general ledger file to account for the discrepancy. At step 770, the system identifies individual depositor records of one or more depositors whose funds are held in the deposit account where the interest payment transaction was made. At step 780, the system calculates what portions of the interest payment to be allocated to each of the identified depositors based on the daily balance of funds held in the deposit account for each identified depositor. At step 790, the system posts the calculated portions of the interest payment to the individual depositor records of each identified depositor.

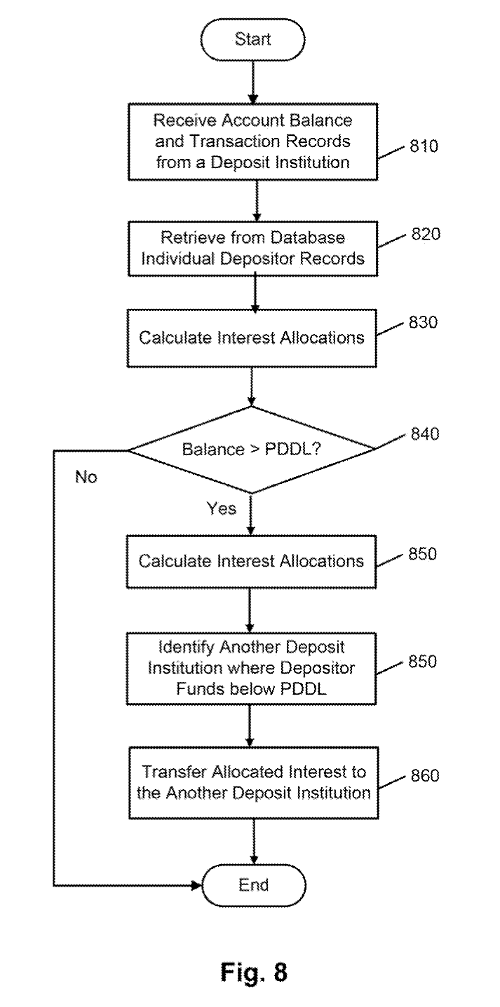

FIG. 8 depicts one example embodiment of the process for allocation of interest payments. At step 810, the system receives from a deposit institution information about account balances and a transaction history for a deposit account that holds funds of a plurality of depositors. At step 820, the system retrieves from a database a plurality of individual depositor records that indicate which depositors hold funds in said first deposit institution, including a balance of funds held by each depositor each day in said first deposit institution. At step 830, the system calculates what portions of the interest payment are allocated to each of the depositors indicated in the depositor records based on the daily balance of funds held in the first deposit institution for each depositor. At step 840, the system determines if the balance of funds held by any depositor in said first deposit institution exceeds a preset deposit limit for such depositor at said first deposit account, where the preset deposit limit for each depositor is set below the SMDIA to ensure that the amount of a depositor's funds held in the first deposit institution remains under the SMDIA, such limit referred to as the per depositor deposit limit or PDDL. If a depositor's funds held at such deposit institution exceeds the PDDL after a transaction, the system, at step 850, identifies a second deposit institution in which the balance of funds of at least one indicated depositor does not exceed the PDDL. Finally, at step 860, the system instructs the first deposit institution to transfer from the deposit account a portion of the interest payment allocated to said at least one indicated depositor to the deposit account at the second deposit institution, so that each of the first and second deposit institutions holds a portion of depositor funds that does not exceed the PDDL.

FIG. 9 depicts one example embodiment of a process for allocating depositor funds during mergers or closures of the participating deposit institutions. At step 910, the system collects and analyzes information about deposit institutions to identify mergers or closures of these institutions. In the event of a merger (or a closure that results in a merger), step 920, between two or more deposit institutions, the system determines, at step 930, if the total amount of a single depositor's funds held in the merged deposit institutions could exceed the PDDL, in which case the system authorizes transfer, at step 940, of the potential excess portion of the depositor's funds held in said merged deposit institution to at least one other deposit account held in at least one other deposit institution so no single depositor holds funds in excess of the PDDL at any single deposit institution. In the event of a closure of a deposit institution, at step 950, the system selects, at step 960, one or more other participating deposit institutions for acquiring depositor funds received from the FDIC with respect to funds previously held in the closed deposit institution, so that the total amount of a single depositor's funds held in each of the acquiring deposit institutions do not exceed the PDDL. Lastly, at step 970, the system allocates the depositor funds between the one or more selected deposit institutions.

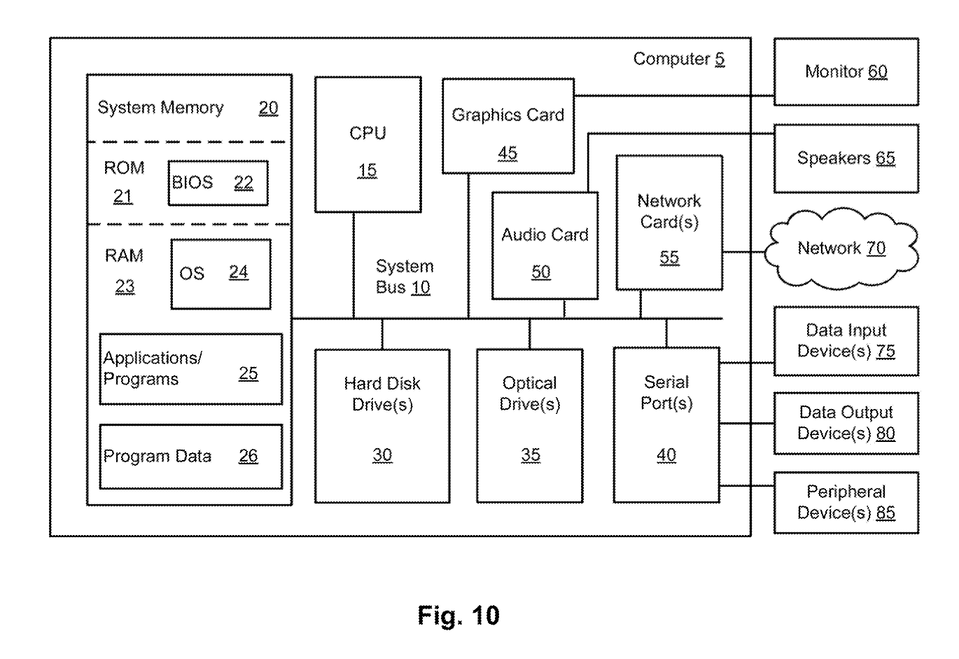

FIG. 10 depicts one example embodiment of a computer system 5, such as a personal computer or application server, suitable for supporting account management system of the present invention. As shown, computer 5 may include one or more processors 15, memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. Processor 15 may include one or more Intel® Core 2 Quad 2.33 GHz processors or other type of microprocessor.

System memory 20 may include a read-only memory (ROM) 21 and random access memory (RAM) 23. Memory 20 may be implemented as in DRAM (dynamic RAM), EPROM, EEPROM, Flash or other type of memory architecture. ROM 21 stores a basic input/output system 22 (BIOS), containing the basic routines that help to transfer information between the components of computer system 5, such as during start-up. RAM 23 stores operating system 24 (OS), such as Windows® XP Professional or other type of operating system, that is responsible for management and coordination of processes and allocation and sharing of hardware resources in computer system 5. System memory 20 also stores applications and programs 25, such as services 306. System memory 20 also stores various runtime data 26 used by programs 25.

Computer system 5 may further include hard disk drive(s) 30, such as SATA magnetic hard disk drive (HDD), and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement processes and methods disclosed herein. Although the exemplary computer system 5 employs magnetic and optical disks, it should be appreciated by those skilled in the art that other types of computer readable media that can store data accessible by a computer system 5, such as magnetic cassettes, flash memory cards, digital video disks, RAMs, ROMs, EPROMs and other types of memory may also be used in alternative embodiments of the computer system.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce® GT 240M or other video card, for interfacing with a monitor 60 or other video reproduction device. System 5 may also include an audio card 50 for reproducing sound via internal or external speakers 65. In addition, system 5 may include network card(s) 55, such as Ethernet, WiFi, GSM, Bluetooth or other wired, wireless, or cellular network interface for connecting computer system 5 to network 70, such as the Internet.

In various embodiments, the processes and methods described herein may be implemented in hardware, software, firmware, or any combination thereof. If implemented in software, the functions may be stored as one or more instructions or code on a non-transitory computer-readable medium. Computer-readable medium includes both computer storage and communication medium that facilitates transfer of a computer program from one place to another. A storage medium may be any available media that can be accessed by a computer. By way of example, and not limitation, such computer-readable medium can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave are included in the definition of medium.

In the interest of clarity, not all of the routine features of the embodiments are shown and described herein. It will be appreciated that in the development of any such actual implementation, numerous implementation-specific decisions must be made in order to achieve the developer's specific goals, and that these specific goals will vary from one implementation to another and from one developer to another. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of limitation, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various embodiments disclosed herein encompass present and future known equivalents to the known components referred to herein by way of illustration. Moreover, while embodiments and applications have been shown and described, it would be apparent to those skilled in the art having the benefit of this disclosure that many more modifications than mentioned above are possible without departing from the inventive concepts disclosed herein.

What is claimed is:

1. A computer-implemented method for managing depositor funds held in a plurality of Federal Deposit Insurance Corporation (FDIC) insured interest-bearing deposit accounts held in a plurality of deposit institutions, the method comprising:
creating and maintaining a general ledger file containing information about an aggregate account balance in each deposit account at a deposit institution and a transaction history of each deposit account and creating a system to retrieve such information from a database;
creating and maintaining in a database a plurality of individual depositor records containing at least information about a daily account balance for each depositor in each of the plurality of deposit accounts at the deposit institutions and a transaction history of each depositor account and creating a system to retrieve such information from a database;
retrieving from the plurality of deposit institutions information about a daily account balance in each deposit account and a daily transaction history of each deposit account; and automatically reconciling each of the deposit accounts, the reconciling comprising:
comparing, for each deposit account, the transactions and the total account balance from the general ledger file with the transactions and daily account balance obtained from a deposit institution;
if the compared account transactions or balances are different, identifying in the daily transaction history obtained from the deposit institution at least one interest payment transaction made by the deposit institution that was not posted to the general ledger file to account for the discrepancy;
creating individual depositor records of one or more depositors whose funds are held in the deposit accounts at deposit institutions and updating such records when the interest payment transaction is made;
calculating what portions of the interest payments are to be allocated to each of the identified depositors based on the daily balance of funds held in the deposit account for each identified depositor; and
posting the calculated portions of the interest payment to the individual depositor records of each identified depositor when such payment is made by a deposit institution.

2. The method of claim 1, wherein identifying in the daily transaction history at least one interest payment transaction made by the deposit institution that was not posted to the general ledger file further comprising:
posting the one or more identified transactions to the general ledger file.

3. The method of claim 1, wherein posting the calculated portions of the interest payment to the individual depositor records of each identified depositor further comprises:
posting the calculated portions of the interest payment to the individual depositor records effective the day the interest was paid by the deposit institution.

4. The method of claim 1, wherein reconciling further comprising:
identifying in a general ledger file a withdrawal of funds transaction made by a depositor and allocating such withdrawal to one or more deposit accounts held at one or more deposit institutions;
identifying in a daily transaction history, obtained from the deposit institution after the withdrawal of funds transaction, an interest payment transaction made by the deposit institution for the period of time while funds were still on deposit in the deposit account;
identifying an individual depositor record of a depositor who made funds withdrawal; and
posting the interest payment to the individual depositor record.

5. The method of claim 1, wherein reconciling further comprising:
identifying in a daily transaction history a fee transaction debited by the deposit institution from the deposit account; and
posting said fee transaction to a separate account in the general ledger file.

6. The method of claim 1, wherein a deposit account includes one of a money market account, savings account or demand account, having a fixed interest rate subject to change by the deposit institution at any time or with a variable interest rate in each case without fixed maturity date.

7. A computer-implemented method for managing depositor funds held in a plurality of Federal Deposit Insurance Corporation (FDIC) insured interest-bearing deposit accounts held in a plurality of deposit institutions, the method comprising:
determining a aggregate deposit limit for each deposit institution based on the current aggregate deposits at said institution to ensure that the amount of depositor funds held in each deposit institution remains below a certain percentage of said institution's total deposits;
determining a per depositor deposit limit (PDDL) for each depositor at each deposit institution in an amount less than standard maximum deposit insurance amount (SMDIA) to ensure that amounts that a depositor has on deposit in any deposit institution at any time is always under the SMDIA;
determining, based on the amount of depositor funds, the established aggregate deposit limit for such deposit institution and the PDDL, a minimum number of different deposit institutions necessary for holding the depositor funds, so that no single depositor holds funds in excess of the SMDIA at any single deposit institution;
instructing a custodian institution holding the depositor funds in a custodian account to allocate the depositor funds to deposit accounts at the plurality of deposit institutions to ensure that no single depositor holds funds in excess of the SMDIA at any single deposit institution;
receiving from the deposit institutions where depositor funds are held or from the custodian institution records of transactions for each of the deposit accounts at such deposit institutions;
determining, based on the records of transactions, if the amount of depositor funds held at any of the deposit institutions exceeds the PDDL for any depositor; and
instructing the custodian institution to reallocate from each deposit institution a portion of a depositor's funds that exceeds the PDDL to at least one other deposit account at least one different deposit institution, whereby each deposit institution holds a portion of a depositor's funds that does not exceed the PDDL and no more than the aggregate deposit limit for such deposit institution, so to ensure that the amount of depositor funds held in each deposit institution remains under the SMDIA.

8. The method of claim 7, wherein instructing the custodian institution to transfer funds between a custodian account to deposit accounts, or from a deposit account at one deposit institution to another deposit institution using automated clearing house.

9. The method of claim 7, wherein determining a number of different deposit institutions for holding a depositor's funds further comprises:
receiving an exclusion list identifying deposit institutions that are not to receive a depositor's funds;
determining, based on the exclusion list, deposit institutions for holding the depositor's funds.

10. The method of claim 7, wherein a deposit account includes one of a money market account, savings account or other demand deposit account, having a fixed interest rate subject to change by the deposit institution at any time or with a variable interest rate, in each case without fixed maturity date.

11. A computer-implemented method for managing depositor funds held in a plurality of Federal Deposit Insurance Corporation (FDIC) insured interest-bearing deposit accounts held in a plurality of deposit institutions, the method comprising:
receiving from a deposit institution information about the balance of funds in one or more deposit accounts at said deposit institution and a transaction history for said deposit accounts that hold funds of a plurality of depositors;
determining if the balance of funds that a depositor has on deposit in such deposit institution exceeds a deposit limit for depositors at such deposit institution where a per depositor deposit limit (PDDL) is set below standard maximum deposit insurance amount (SMDIA) for each depositor to ensure that the amount of a single depositor's funds held in the first deposit institution remains under the SMDIA;
if the balance of funds that a single depositor has on deposit exceeds the PDDL, identifying in the transaction history an interest payment transaction made by the deposit institution;
retrieving from a database a plurality of individual depositor records that indicate which depositors hold funds in said deposit institution, a balance of funds held by each depositor in said deposit institution on each day;
calculating what portions of the interest payment are allocated to each depositor indicated in the depositor records based on the daily balance of funds held in the deposit institution for each depositor;
identifying a deposit account held in a second deposit institution in which the balance of funds of at least one indicated depositor does not exceed the PDDL; and
instructing the first deposit institution to transfer from the first deposit account an amount at least equal to a portion of the interest payment allocated to said at least one indicated depositor to the deposit account held in the second deposit institution, whereby each of the first and second deposit institutions holds a portion of such depositor's funds that does not exceed the PDDL.

12. The method of claim 11, wherein instructing the first deposit institution to transfer from the deposit account at such deposit institution an amount at least equal to the allocated portion of the interest payment to the deposit account held at the second deposit institution using automated clearing house.

13. The method of claim 11, wherein instructing the first deposit institution to transfer from the deposit account at said deposit institution at least the allocated portion of the interest payment to the deposit account held in the second deposit institution further comprises:
instructing the first deposit institution to transfer from the deposit account at least a portion of the interest payment allocated to said at least one indicated depositor into a custodian account for such depositor held at a custodian institution; and
instructing the custodian institution to transfer the received portion of the interest payment allocated to said at least one indicated depositor to the deposit account held at the second deposit institution.

14. The method of claim 11, wherein a deposit account includes one of a money market account, savings account or demand account, having a fixed interest rate subject to change by the deposit institution at any time or with a variable interest rate in each case without fixed maturity date.

15. A computer-implemented method for managing depositor funds held in a plurality of Federal Deposit Insurance Corporation (FDIC) insured interest-bearing deposit accounts held in a plurality of deposit institutions, the method comprising:
collecting information about each of said plurality of deposit institutions;
analyzing the information to identify mergers or closures of said deposit institutions;
in the event of a merger between two or more of said deposit institutions or closure of a deposit institution that results in a merger, determining if the total amount of any single depositor's funds held in the merged deposit institutions exceeds a per depositor deposit limit (PDDL) for each depositor at each deposit institution in an amount less than standard maximum deposit insurance amount (SMDIA); and
if the total amount of funds of any depositor exceeds PDDL, authorizing transfer of the excess portion of the depositor's funds held in said merged deposit institutions to at least one other deposit account held in at least one other deposit institution, so that no single depositor holds funds in excess of the PDDL at any single deposit institution.

16. The method of claim 15, wherein if the depositor funds held in the closed deposit institution are not acquired by another deposit institution, generating a FDIC-required file containing information about depositor funds held in the closed deposit institution and transferring such file to the FDIC or to the custodian for forwarding to the FDIC to obtain insurance proceeds on behalf of each depositor that had deposits in such closed deposit institution.

17. The method of claim 15, wherein authorizing transfer of the excess portion of the depositor funds using automated clearing house.

18. The method of claim 15, wherein authorizing transfer of the excess portion of the depositor funds further comprises:
authorizing transfer of the excess portion of depositor funds to a custodian account for each depositor held in a custodian institution; and
instructing the custodian institution to transfer the received excess portion of a depositor's funds to the one other deposit accounts held in the at least one other deposit institution.

19. The method of claim 15, wherein a deposit account includes one of a money market account, savings account or demand account, having a fixed interest rate subject to change by the deposit institution at any time or with a variable interest rate in each case without fixed maturity date.

20. A computer-based system for managing depositor funds held in a plurality of Federal Deposit Insurance Corporation (FDIC) insured interest-bearing deposit accounts held in a plurality of deposit institutions, the computer-based system comprising:
a memory configured to store:
a general ledger file containing information about a total account balance in each deposit account at each deposit institution and a transaction history of each deposit account;
a plurality of individual depositor records containing at least information about a daily account balance for each depositor in each of the plurality of deposit accounts and a transaction history of each deposit account; and
a processor coupled to the memory, the processor configured to:
retrieve from the plurality of deposit institutions information about a daily account balance in each deposit account and a daily transaction history of each deposit account; and
reconcile each of the deposit accounts, the reconciling comprising:
comparing, for each deposit account, the transactions and the total account balance from the general ledger file with the daily transactions and account balance obtained from a deposit institution;
if the compared account transactions or balances are different, identify in the daily transaction history obtained from the deposit institution at least one interest payment transaction made by the deposit institution that was not posted to the general ledger file to account for the discrepancy;
identify individual depositor records of one or more depositors whose funds are held in the deposit account where the interest payment transaction was made;
calculate what portions of the interest payment to be allocated to each identified depositor based on the daily balance of funds held in the deposit account for each identified depositor; and
post the calculated portions of the interest payment to the individual depositor records of each identified depositor.

21. A computer-based system for managing depositor funds held in a plurality of Federal Deposit Insurance Corporation (FDIC) insured interest-bearing deposit accounts held in a plurality of deposit institutions, the computer-based system comprising a processor configured to:
determine a deposit limit for each deposit institution based on the current aggregate deposits at each said institution to ensure that the amount of depositor funds deposited through the system held in each deposit institution remains below a certain percentage of such institution's total deposits, such limit referred to as the aggregate deposit limit;
determine, per depositor deposit limit (PDDL) for each depositor at each deposit institution in an amount less than standard maximum deposit insurance amount (SMDIA) to ensure that amounts that a depositor has on deposit in any deposit institution at any time is always under the SMDIA;
determining, based on the amount of depositor funds, the established aggregate deposit limit for such deposit institution and the PDDL, a minimum number of different deposit institutions necessary for holding the depositor funds, so that no single depositor holds funds in excess of the PDDL at any single deposit institution;
instruct a custodian institution holding the depositor funds in a custodian account to allocate the depositor funds to deposit accounts at the plurality of deposit institutions to ensure that no single depositor holds funds in excess of the PDDL at any single deposit institution;
receive from the deposit institutions where depositor funds are held records of transactions for each of the deposit accounts;
determine, based on the records of transactions, if the amount of any single depositor's funds held in the deposit institution exceeds the PDDL;
instruct the custodian institution to reallocate from one or more deposit accounts a portion of any depositor's funds that exceeds the PDDL to at least one other deposit account at least one different deposit institution, so that each deposit institution holds a portion of depositor funds that does not exceed the PDDL, so that the amount of depositor funds held in each deposit institution remains under the SMDIA;
determine, based on the records of transactions, if the amount of depositor funds held in the deposit institution exceeds the aggregate deposit limit; and
instruct the custodian institution to reallocate from one or more deposit accounts depositors' funds that exceed the aggregate deposit limit to at least one other deposit account at least one different deposit institution, so that each deposit institution holds aggregate depositor funds that does not exceed the aggregate deposit limit for each deposit institution.

22. A computer-based system for managing depositor funds held in a plurality of Federal Deposit Insurance Corporation (FDIC) insured interest-bearing deposit accounts held in a plurality of deposit institutions, the computer-based system comprising a processor configured to:
receive from a first deposit institution information about balance of funds and a transaction history for a deposit account that holds funds of a plurality of depositors;
determine, a per depositor deposit limit (PDDL) for each depositor at said first each deposit institution in an amount less than standard maximum deposit insurance amount (SMDIA) to ensure that amounts that a depositor has on deposit in such deposit institution at any time is always under the SMDIA;
retrieve from a database a plurality of individual depositor records that indicate the balance of funds held by each depositor in the deposit accounts at said first deposit institution each day;
calculate what portions of the interest payment are allocated to each of the depositors indicated in the depositor records based on the daily balance of funds held in the first deposit institution for each depositor;
if the records indicate that the amount of a depositor's funds held in said first deposit institution exceeds the PDDL,
identify a deposit account held in a second deposit institution in which the balance of funds of at least one indicated depositor does not exceed the PDDL; and
instruct the first deposit institution to transfer from the deposit account the amount that said at least one indicated depositor holds in said first deposit institution in excess of the PDDL to a deposit account held in the second deposit institution, whereby each of the first and second deposit institutions holds a portion of depositor funds that does not exceed the PDDL.

23. A computer-based system for managing depositor funds held in a plurality of Federal Deposit Insurance Corporation (FDIC) insured interest-bearing deposit accounts held in a plurality of deposit institutions, the computer-based system comprising a processor configured to:
collect information about each of said plurality of deposit institutions;
analyze the information to identify mergers or closures of said deposit institutions;
in the event of a merger between two or more of said deposit institutions or closure of a deposit institution that results in a merger, determine if the total amount of any single depositor's funds held in the merged deposit institutions exceeds a per depositor deposit limit (PDDL) for each depositor at each deposit institution in an amount less than standard maximum deposit insurance amount (SMDIA); and
if the total amount of funds of any depositor exceeds PDDL, authorize transfer of the excess portion of the depositor's funds held in said merged deposit institutions to at least one other deposit account held in at least one other deposit institution, so that no single depositor holds funds in excess of the PDDL at any single deposit institution.
